(19) United States
(12) Patent Application Publication
(10) Pub. No.: US 2006/0177546 A1
(43) Pub. Date: Aug. 10, 2006

(54) Method for dyeing the albumen of cooked and peeled eggs and a dyed cooked and peeled egg

(76) Inventor: Myrna Rae Hoehne, San Antonio, TX (US)

Correspondence Address: Charles W. Hanor, P.C., 750 Rittiman Road, San Antonio, TX, 78209, US

(21) Appl. No.: 11/053,803

(22) Filed: Feb. 9, 2005

(51) Int. Cl. A23L 1/27

(52) U.S. Cl. 426/250

(57) ABSTRACT

A method for dyeing the albumen of cooked and peeled eggs and a dyed cooked and peeled egg are provided by applying a dye to the egg after the eggshell has been cooked and peeled. The dye penetrates only an outer portion of the egg's albumen. Thus, the remainder of the egg albumen comprised of the inner portion of the albumen and the egg yolk remain undyed.

### CROSS-REFERENCE TO RELATED APPLICATIONS

NA

### STATEMENTS REGARDING FEDERALLY SPONSORED RESEARCH OR DEVELOPMENT

NA

### REFERENCE TO A MICROFICHE APPENDIX

NA

### BACKGROUND OF THE INVENTION

1. Field of the Invention

The present invention is related to the dyeing or coloring of eggs and is particularly concerned with a method for producing attractive dye effects to the albumen of an egg. The resultant dyed portion of the egg may then be cut, shredded, or shaved from the egg mass. These shavings may be used for various purposes, including, but not limited to, decorating other foodstuff.

Coloring of eggshells for decorative purposes is an activity generally enjoyed during holidays. Easter, Christmas, and Thanksgiving are such holidays during which eggshell coloring is prominent. The present invention may also be used during holidays as an edible decoration. For many years, eggshells have been dyed by dipping the eggshell of hardboiled eggs in warm water containing a water-soluble dye. In addition to the dye, vinegar is added to the warm water to etch the eggshells to help the dye to adhere. The dye is generally placed in the water as a tablet or powder or liquid. You may also etch the egg shells during the cooking process to enhance the ability of the dye to adhere to the eggshells.

The present invention relates to a method of dyeing the egg's albumen with an aqueous dyeing medium and the dyed cooked and peeled egg. This requires that the eggshell be removed after the egg has been hard boiled. The meaning of hard-boiled is to boil an egg until the yolk and white have become firm or solid. The hardboiled and peeled egg is put in a dye medium and the dye is allowed to penetrate for a desired time. After the appropriate color is achieved from immersion into or application of the dyeing medium, the colored albumen may be shaved or cut from the portion of the egg that has not been penetrated by the dye.

An object of the invention is to increase the aesthetic appearance of cooked eggs.

Another object of the invention is to increase the aesthetic appearance of dishes that utilize cooked and peeled hard boiled eggs.

2. Description of the Related Art

U.S. Pat. No. 5,565,229 discloses a press and method for tie-dyeing eggs. The press comprises a planar material having a surface, centerfold, and two depressions. The two depressions align to define a closed void which is ovoid in shape.

U.S. Pat. No. 5,787,838 discloses a device and method for decorating an egg comprised of a paper bag. The inner surface of the bag is coated with a water-soluble transfer dye, such that when an egg with a wetted surface comes into contact with the dye on the inner surface of the bag, the dye releases from the bag and transfers onto the egg, coloring the egg.

U.S. Pat. No. 4,181,745 discloses a method for decorating the shells of eggs by applying a dry granular dyeing medium to the hydrated shell. The dyeing medium includes dye and rock salt. The shell may be wetted with water or vinegar.

U.S. Pat. No. 4,664,925 discloses a means and compositions for pre-treating whole, intact eggs in a boiling solution at about pH 3.2-3.6 with a buffer, preferably cream of tarter, prior to dyeing and coating the egg with a flavor fragrance. A kit for treating, dyeing, and adding flavor fragrance is also disclosed.

U.S. Pat. No. 4,371,555 discloses a method for dyeing eggs whereby a hydrophobic granular, water-insoluble solid to the eggshell followed by the dyeing of the egg utilizing a conventional aqueous dyestuff. The granular solid is removed from the egg following the dyeing process.

U.S. Pat. No. 4,693,205 discloses an egg decorating kit comprised of decorating material in a fluid form which is dripped onto the egg while the egg is being held in position to allow the decorating material to flow there over and the material is particularly formulated to be fast drying. The apparatus for supporting the egg during the decorating process includes a number of support legs arranged in spaced relation to each other to receive an egg placed thereon and hold the same above a drip tray section. The egg supporting structure includes the upstanding legs arranged in overlying relationship to a tray for collection of excess decorative material.

U.S. Pat. No. 5,693,352 discloses a device and method for decorating an object such as an egg. The device includes a resilient band adapted for placement about the perimeter of the object to be decorated. The band prevents a colorant or dye from dyeing the object about the perimeter the band is placed.

### BRIEF SUMMARY OF THE INVENTION

The present invention includes a method for coloring a portion of the albumen, or white, of the egg and the resulting dyed cooked and peeled egg. An aqueous dyeing medium is applied to the egg after it is boiled and peeled. The dyeing process generally does not penetrate the entire egg albumen but rather only the outer layer of the egg albumen when the egg is maintained in the dye for the proper time. This leaves the inner layers of the albumen undyed.

### BRIEF DESCRIPTION OF THE DRAWING

FIG. 1 is a cross-section of the fully cooked egg with no shell displaying the approximate depth to which the aqueous dyeing medium penetrates the albumen.

### DETAILED DESCRIPTION OF THE INVENTION

This invention is related to a unique method of dying/coloring of hard-boiled eggs without the shell. The invention requires the removal of the shell from a hard-boiled egg. The peeled hard-boiled egg is then dyed which produces a more aesthetically attractive and readily edible colored egg. Furthermore, the invention is more appealing from an entertaining and commercial restaurant or deli application as it eliminates the messy removal of the eggshell at the dining table. The resultant dyed/colored egg may then be served whole, sliced or chopped. The chopped colored eggs make beautiful egg salad, potato salad in which eggs are present, a variety of other salads, decorating other foods and hors d'oeuvres for entertaining and basic family enjoyment.

The invention is a method of dying or coloring eggs whereby the eggshell is peeled from the hard-boiled egg mass and then the cooked egg is submersed in a combination of water and edible, safe, food colors which may contain FDA propylene glycol as a preservative for foodstuffs to achieve the delicate pastel or brilliant colors desired. The egg is turned constantly in the color so that the color is even, or the egg may be held with only one end of the egg submersed in the color and then turned to color the other end in a different color. The dying/coloring process does not penetrate the entire egg albumens (thick or thin), the vitelline membrane or the yolk itself, but rather it penetrates only the outer layer of the egg white or thin albumen. This leaves the inner layers of the albumen, called the thick albumen, in its natural, undyed/uncolored white state.

The unique nature and beauty of the invention is that unlike other applications where food color is used, the dye used and the dye time provide that color only permeates an outer portion of the egg albumen, not the entire albumen or the vitelline or egg yolk. Once dyed, the hard-boiled, peeled egg has a thin coating of dyed albumen that is aesthetically appealing and the food coloring is safe and has no flavor that will alter the normal egg taste or cause the cooked egg to deteriorate at a more rapid rate. The egg once dyed/colored has an extended shelf-life both in the refrigerator (approximately one week) or while being left on a serving table during a meal the egg does not begin the spoilage process for at least an hour and can safely last up to two hours unrefrigerated.

For an egg prepared according to the invention, even after a week of being refrigerated, the food color does not penetrate the thick albumen, vitelline which is the membrane surrounding the yolk of the egg or the physical yolk of the egg. The higher the grade of the egg, the thicker the thin albumen is, and therefore its thickness creates a natural shield from the thick albumen thus leaving the thick white albumen untouched by the dying process, remaining in a natural, unaltered state.

Unlike known other methods of dying/coloring eggs, whereby the egg shell of the cooked egg is dyed with natural food coloring combined with vinegar and water to set the color within the shell, or with tablet dyes of the edible food safe type, which contain dehydrated vinegar and other materials to create absorption of the colors by eggshell during the dyeing process, the known existing method of dyeing or coloring hard-boiled eggs begins once the cooked egg is removed from the heat and then placed into a small container of water, vinegar and food coloring with the eggshell still intact around the egg. One might also etch the eggshells during the cooking process to enhance the ability to the dye to adhere to the eggshells. Hard-boiled eggs dyed in this fashion may absorb some of the strong odor and flavor of the vinegar and the shelf life, refrigerated or not, is a matter of hours before the vinegar permeates the entire egg. Vinegar has the ability to penetrate and break down the albumen layers, vitelline and egg yolk causing deterioration.

An example of the present invention includes boiling the eggs generally by submerging the eggs in a boiling aqueous solution of a buffer at an optimum pH of 3.2-3.6. The eggs may also be cooked using microwaves to achieve a hardboiled eggs whereby the yolk and white have become firm or solid. There are numerous prior art methods for cooking eggs that all produce an egg having a hard or solid yoke and egg white. This type of cooked egg is commonly called a hardboiled or hard cooked egg. Immediately after cooking, the eggs are submersed in a cold water solution to contract the inner egg mass including the albumen and yoke from the outer shell. This also stops the cooking process to help preserve the egg and the appearance of the egg. This makes it easier to remove the shell from the hard cooked egg.

To understand the dyeing of the egg, a brief explanation of the components of an egg follows. The inner shell membrane of an egg is the thin membrane located between the outer shell membrane and the albumen. The outer shell membrane is the thin membrane located just inside the shell. The shell is the hard, protective coating of the egg. The shell is semi-permeable to let gas exchange occur, but keeps other substances from entering the egg. The shell is made of calcium carbonate. The thick albumen is the white part of the egg white (albumen) located nearest the yolk. The thin albumen is the watery part of the egg white (albumen) located farthest from the yolk. The vitelline (yolk) membrane is the membrane that surrounds the yolk. The yolk is the yellow, inner part or mass of the egg where an embryo can form. The yolk contains the food that will nourish the embryo as it grows.

The eggshell is subsequently peeled from the boiled egg exposing the albumen, or egg white, to the ambient air. The albumen should not be torn or damaged during the peeling step so that an esthetically appealing product is produced and so that the dye penetrates to the desired depth.

The peeled eggs may next be immersed into an aqueous dyeing medium including dyes comprising water, propylene glycol, yellow 5, yellow 6, red 40 and blue 1. Vinegar is absent from this dyeing process. Vinegar is not used in the process to avoid pickling of the egg. The treated eggs of the invention are not pickled. The depth of penetration of the egg white depends on the type of dye and the length of immersion.

As with all food colors when applied to food, it is a normal reaction for the colors to penetrate the entire mass, not just the outer surface portion of the mass. However, even when the eggs are left in the food color and water for an extended period of time, the color still does not penetrate the thick albumen, vitelline or the yolk of the egg. Furthermore, when left under refrigeration for a lengthy period of time the food coloring or dye still does not penetrate the yolk. It is understood that one should only use food extract dyes for coloring food, which are safe, edible and non-toxic.

Methods other than immersion may be used dye the egg white. Any method of applying the aqueous dyeing medium to the egg may be utilized. Examples of application methods include immersion of the egg in the dye, spraying the dye onto the egg or brushing the dye onto the egg. Other dyes may be applied to a previously dyed egg repetitively in one or more fashions utilizing different color combinations.

This method of dyeing does not cause penetration of the vitelline membrane surrounding the egg yolk. Thus, only a portion of the albumen or egg white is colored, and the remainder of the egg remains its natural and undyed color.

The peeled egg is submersed in a combination of water and food color made from food color extract, propylene glycol an agent used for preserving foodstuffs, yellow 5, yellow 6, red 40 and blue 1, or any mixture thereof to achieve any color in the spectrum. Vinegar is not used in this dying process. The depth of penetration of the color into the thin albumen depends on the amount of time the boiled, peeled egg is left submersed in the food color water mixture. Methods other than immersion may be used. Immersion is not the only method of applying food dye to the egg white, however it is the preferred method. Other methods of applying the aqueous food dying/coloring medium to the egg may be utilized. Examples include immersion of the egg in the dye, spraying the dye onto the egg or brushing the dye onto the egg. Other colors may be applied to the cooked, peeled egg and may be practiced repetitively in one or more fashions utilizing and achieving different color combinations.

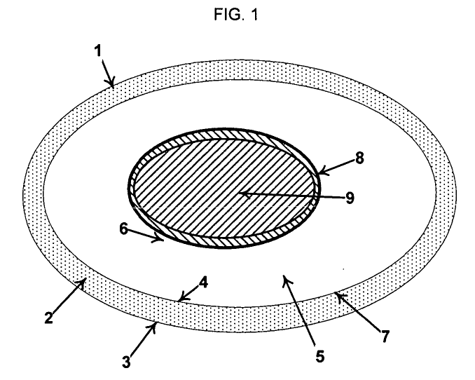

FIG. 1 shows cooked and peeled egg 1 and the approximate depth to which the dyeing medium penetrates egg 1. The depth of the thin albumen penetrated by the dyeing medium may differ with each egg and is based partly upon the grade of the egg used, but will not normally penetrate the thick albumen. The depth of the dye penetration will vary based upon the length of time and the volume of the aqueous dye applied to the egg. The length of time of the dying process is related to the extent of the depth of color brilliance or pastel color of the egg desired. Accordingly, increasing the application time of the aqueous food color dye will generally increase the depth and brilliance (shade) of the egg color.

The thin albumen 2 is preferably the only part of the egg that is colored or dyed and is defined by outer surface 3 and inner surface 4. The dye preferably does not penetrate thick albumen 5 which includes an inner boundary surface defined by surface 6 and an outer boundary surface defined by surface 7 or vitelline membrane 8 which is the clear casing that encloses yolk 9. The dye also does not color egg yolk 9.

As seen in FIG. 1, the dye time is limited so the dye approximately penetrates only the outer layer known as the thin albumen 2 and generally does not penetrate thick albumen 5. Thus, the yolk and inner portion of the thick albumen 5 closest to the yolk remain undyed.

After completing the dyeing of an outer layer of the albumen, the eggs may be used to prepare various dishes by cutting and slicing the dyed eggs. The colored albumen layer may be used for several purposes including, but not limited to, decorating foods. The colored layer may be used to decorate salads, egg salads, deviled eggs, sandwiches, pizza, rice salad, macaroni, creamed eggs, and any other foodstuff. As will be apparent when a cooked and peeled egg is dyed with the method of the invention and the egg is sliced for serving or adding to a dish, the color added to the outer layer of the albumen or egg white will be visible and enhance the aesthetic appeal of the dish.

The dyed, cooked and peeled eggs may be packaged for sale in a clear packaging. The dyed outer surfaces of the packaged eggs provide an eye-catching and appealing display. The dyed, cooked and peeled eggs are more aesthetically appealing which will increase their desirability.

After completing the dying process of the egg, the egg may be eaten individually just as a normal hard-boiled egg would be eaten, or it may be used in various salads and hors d'oeuvres. The colored, hard-boiled eggs may be used for several purposes, including, but not limited to, decorating foods such as salads, egg salad, meat salads, sandwiches, deviled eggs, rice salad, macaroni, vegetable salads, creamed eggs and any other foodstuff. It will be apparent, when the cooked and peeled egg is dyed with the method of this invention, the egg can be served/used whole, sliced or chopped for serving or adding to a food dish. The color added to the outer layer of the thin albumen (egg white) will be visible and enhance the aesthetic appeal of the egg and food dish. Furthermore, the food coloring on/in thin albumen 2 should not transfer color to any other food product into which it is placed, such as egg salad, meat salads, vegetable salads, etc. An exception to color transfer is when one colored egg is placed next to another colored egg at which time and due to the physical composition of the egg itself, color may be transferred when the eggs are whole and wet. Placing one colored egg next to another color can provide a fun polka-dot coloring effect on the eggs. This transfer of color should occur only while the egg is still warm and wet from the food color. The eggs should not transfer their colors once placed in salad due to the oil of the salad when oil is added to the salad. This is yet another unique nature of the invention without the use of vinegar.

The cooked, peeled and dyed eggs may be packaged for sale in protective, food safe, air-tight clear blister packaging which is aesthetically appealing to both the consumer and food-service industry. The cooked, peeled (shelled) and dyed/colored eggs may also be packaged as chopped, colored eggs in protective, food-safe, air-tight, protective packaging for the purpose of using in food preparation of salads and a variety of other food combination uses or to be eaten alone just as one would eat a regular hard-boiled egg.

Although the foregoing specific details describe various embodiments of the invention, persons reasonably skilled in the art will recognize that various changes may be made in the details of the method and apparatus of this invention without departing from the spirit and scope of the invention as defined in the appended claims. Therefore, it should be understood that, unless otherwise specified, this invention is not to be limited to the specific details shown and described herein.

We claim:

1. The method for dyeing a portion of the albumen layer of eggs, comprising the steps of:
cooking the eggs in the shell until the yolk and albumen are hard and solid;
peeling the shells from the cooked eggs;
covering the cooked, peeled eggs with a dyeing medium that is safe for human consumption; and
applying the dyeing medium until the dye has penetrated a portion of the albumen and less than to the vitelline membrane so that only a portion of the albumen is dyed.

2. The method in claim 1 wherein the cooked, peeled egg is submersed into a liquid dyeing medium comprised of food color extract and water to allow the entire thin albumen to be covered to achieve total color of the over-all exterior of the egg, and not the thick albumen, vitelline or yolk.

3. The method in claim 1 wherein the cooked, peeled egg is submersed into a liquid dyeing medium comprised of food color extract, propylene glycol and water to allow the entire thin albumen to be covered to achieve total color of the over-all exterior of the egg, and not the thick albumen, vitelline or yolk.

4. The method in claim 1 wherein the cooked, peeled egg is maintained in the dye medium until the dye penetrates the thin albumen to a depth to provide a colored albumen portion and a non-colored albumen portion.

5. A cooked and peeled egg having a dyed outer portion of the albumen, comprising:
a cooked and peeled egg with the yoke and albumen that are hard and solid; and
an outer portion of the albumen being dyed with a dye safe for human consumption to a depth less than to the vitellin membrane so that only a portion of the albumen is dyed.

6. The cooked and peeled egg in claim 5 wherein the cooked, peeled egg is subjected to a dyeing medium so that the depth of penetration of the dye is about the thickness of the thin albumen.

7. The cooked peeled egg in claim 5 whereby the cooked, peeled egg is maintained in the dye medium until the dye penetrates the albumen to a depth to provide a colored albumen portion and a non-colored albumen portion.

8. The cooked peeled egg claim 5 wherein the dyeing medium comprises of food color extract and water to allow the entire thin albumen to be covered to achieve total color of the over-all exterior of the egg, and not the thick albumen, vitelline or yolk.

9. The cooked peeled egg claim 5 wherein the dyeing medium comprises of food color extract, propylene glycol and water to allow the entire thin albumen to be covered to achieve total color of the over-all exterior of the egg, and not the thick albumen, vitelline or yolk.
